(19) United States
(12) Patent Application Publication
(10) Pub. No.: US 2019/0126604 A1
(43) Pub. Date: May 2, 2019

(54) SUBSTRATE LAMINATION METHOD AND SUBSTRATE LAMINATION DEVICE

(71) Applicants: BOE TECHNOLOGY GROUP CO., LTD., Beijing (CN); BEIJING BOE SPECIAL DISPLAY TECHNOLOGY CO., LTD., Beijing (CN)

(72) Inventor: Huizhong Zhu, Beijing (CN)

(73) Assignees: BOE TECHNOLOGY GROUP CO., LTD., Beijing (CN); BEIJING BOE SPECIAL DISPLAY TECHNOLOGY CO., LTD., Beijing (CN)

(21) Appl. No.: 16/044,991

(22) Filed: Jul. 25, 2018

(30) Foreign Application Priority Data
Oct. 27, 2017 (CN) 201711022999.X

(51) Int. Cl. B32B 37/12; G02F 1/13

(52) U.S. Cl. CPC B32B 37/12; G02F 1/1303

(57) ABSTRACT

A substrate lamination method and a substrate lamination device are provided. The substrate lamination method is applied to laminate a first to-be-laminated substrate onto a second to-be-laminated substrate in a full lamination mode. A lamination surface of the first to-be-laminated substrate includes a plurality of first regions, and a lamination surface of the second to-be-laminated substrate includes a plurality of second regions each corresponding to a respective one of the first regions. The substrate lamination method includes: acquiring warpage of each of the first regions and warpage of the second region corresponding to the first region; and calculating an amount of adhesive to be filled between each of the first regions and the second region corresponding to the first region in accordance with the warpage of the first region, the warpage of the second region and a predetermined thickness of the adhesive.

### CROSS-REFERENCE TO RELATED APPLICATION

The present application claims priority to the Chinese patent application No. 201711022999.X filed on Oct. 27, 2017, which is hereby incorporated by reference in its entirety.

### TECHNICAL FIELD

The present disclosure relates to the field of display technology, in particular to a substrate lamination method, and a substrate lamination device.

### BACKGROUND

Usually, a cover plate or a touch panel needs to be laminated onto a display panel, e.g., a liquid crystal panel or an organic light-emitting diode (OLED) panel in a frame-type lamination mode or full lamination mode. In the frame-type lamination mode, an edge of the to-be-laminated display panel is laminated to an edge of a to-be-laminated medium. However, due to an air gap between the display panel and the to-be-laminated medium, reflectivity of a resultant display product may increase, so readability of the display product in a strong light environment may be adversely affected. In the full lamination mode, an adhesive is fully filled between the to-be-laminated display panel and the to-be-laminated medium. The display product in the full lamination mode is significantly advantageous over the display product in the frame-type lamination mode in terms of the readability in the strong light environment.

### SUMMARY

An object of the present disclosure is to provide a substrate lamination method and a substrate lamination device.

In one aspect, the present disclosure provides in some embodiments a substrate lamination method for laminating a first to-be-laminated substrate onto a second to-be-laminated substrate in a full lamination mode. A lamination surface of the first to-be-laminated substrate includes a plurality of first regions, and a lamination surface of the second to-be-laminated substrate includes a plurality of second regions, and the first regions correspond one-to-one with the second regions. The substrate lamination method comprises: acquiring warpage of each of the first regions and warpage of the second region corresponding to the first region; and calculating an amount of adhesive to be filled between each of the first regions and the second region corresponding to the first region in accordance with the warpage of the first region, the warpage of the second region corresponding to the first region and a predetermined thickness of the adhesive.

In a possible embodiment of the present disclosure, the substrate lamination method further comprises: subsequent to calculating the amount of the adhesive to be filled between each of the first regions and the second region corresponding to the first region, coating the calculated amount of the adhesive at each of the first regions and/or the second region corresponding to the first region, wherein the adhesive is liquid adhesive.

In a possible embodiment of the present disclosure, the acquiring the warpage of each of the first regions and the warpage of the second region corresponding to the first region comprises: acquiring a surface feature image of each of the first regions through an image collector, determining a warpage distribution of the first region in accordance with the surface feature image of the first region, and calculating average warpage of the first region in accordance with the warpage distribution of the first region, to determine the average warpage of the first region as the warpage of the first region; and acquiring a surface feature image of each of the second regions through the image collector, determining a warpage distribution of the second region in accordance with the surface feature image of the second region, and calculating average warpage of the second region in accordance with the warpage distribution of the second region, to determine the average warpage of the second region as the warpage of the second region.

In a possible embodiment of the present disclosure, the calculating the amount of the adhesive to be filled between each of the first regions and the second region corresponding to the first region in accordance with the warpage of each of the first regions, the warpage of the second region corresponding to the first region and the predetermined thickness of the adhesive comprises: calculating an actual thickness H of the adhesive at each of the first regions in accordance with the warpage of each of the first regions, the warpage of the second region corresponding to the first region and the predetermined thickness of the adhesive; and obtaining the amount L of the adhesive to be filled between each of the first regions and the second region corresponding to the first region through multiplying the actual thickness H by an area S of the first region.

In a possible embodiment of the present disclosure, the coating the calculated amount of the adhesive at each of the first regions and/or the second region corresponding to the first region comprises: coating the adhesive of a predetermined pattern at each of the first regions and/or the second region corresponding to the first region, wherein the predetermined pattern comprises at least one of an X shape and a Y shape.

In a possible embodiment of the present disclosure, the number of the first regions is equal to the number of the second regions, each of the first regions has a same area and a same shape as the second region corresponding to the first region, and a relative position of each of the first regions on the first to-be-laminated substrate is the same as a relative position of the second region corresponding to the first region on the second to-be-laminated substrate, to enable that each of the first regions completely coincides with the second region corresponding to the first region after the first to-be-laminated substrate has been laminated onto the second to-be-laminated substrate.

In another aspect, the present disclosure provides in some embodiments a substrate lamination device for laminating a first to-be-laminated substrate onto a second to-be-laminated substrate in a full lamination mode, wherein a lamination surface of the first to-be-laminated substrate comprises a plurality of first regions, and a lamination surface of the second to-be-laminated substrate comprises a plurality of second regions, and the first regions correspond one-to-one with the second regions. The substrate lamination device comprises: a warpage acquisition module configured to acquire warpage of each of the first regions and warpage of the second region corresponding to the first region; and a calculation module configured to calculate an amount of adhesive to be filled between each of the first regions and the second region corresponding to the first region in accordance with the warpage of the first region, the warpage of the second region corresponding to the first region and a predetermined thickness of the adhesive.

In a possible embodiment of the present disclosure, the substrate lamination device further includes: a coating module configured to coat the calculated amount of the adhesive at each of the first regions and/or the second region corresponding to the first region, wherein the adhesive is liquid adhesive.

In a possible embodiment of the present disclosure, the warpage acquisition module includes: an image collector configured to acquire a surface feature image of each of the first regions and a surface feature image of the second region corresponding to the first region; and a processing circuitry configured to determine a warpage distribution of the first region in accordance with the surface feature image of the first region, calculate an average warpage of the first region in accordance with the warpage distribution of the first region to determine the average warpage of the first region as the warpage of the first region, determine a warpage distribution of the second region in accordance with the surface feature image of the second region, and calculate an average warpage of the second region in accordance with the warpage distribution of the second region to determine the average warpage of the second region as the warpage of the second region.

In a possible embodiment of the present disclosure, the calculation module is further configured to: calculate an actual thickness H of the adhesive at each of the first regions in accordance with the warpage of each of the first regions, the warpage of the second region corresponding to the first region and the predetermined thickness of the adhesive; and obtain the amount L of the adhesive to be filled between each of the first regions and the second region corresponding to the first region through multiplying the actual thickness H by an area S of the first region.

In a possible embodiment of the present disclosure, the coating module is further configured to: coat the adhesive of a predetermined pattern at each of the first regions and/or the second region corresponding to the first region, wherein the predetermined pattern comprises at least one of an X shape and a Y shape.

In a possible embodiment of the present disclosure, the number of the first regions is equal to the number of the second regions, each of the first regions has a same area and a same shape as the second region corresponding to the first region, and a relative position of each of the first regions on the first to-be-laminated substrate is the same as a relative position of the second region corresponding to the first region on the second to-be-laminated substrate, to enable that each of the first regions completely coincides with the second region corresponding to the first region after the first to-be-laminated substrate has been laminated onto the second to-be-laminated substrate.

In yet another aspect, the present disclosure provides in some embodiments a substrate lamination device for laminating a first to-be-laminated substrate onto a second to-be-laminated substrate in a full lamination mode. A lamination surface of the first to-be-laminated substrate includes a plurality of first regions, and a lamination surface of the second to-be-laminated substrate includes a plurality of second regions each corresponding to a respective one of the first regions. The substrate lamination device includes a memory, a processor and a computer program stored in the memory and capable of being executed by the processor. The computer program is executed by the processor so as to implement the above-mentioned substrate lamination method.

In still yet another aspect, the present disclosure provides in some embodiments a computer-readable storage medium storing therein a computer program. The computer program is executed by a processor so as to implement the above-mentioned substrate lamination method.

### BRIEF DESCRIPTION OF THE DRAWINGS

In order to illustrate the technical solutions of the present disclosure in a clearer manner, the drawings desired for the present disclosure will be described hereinafter briefly. Obviously, the following drawings merely relate to some embodiments of the present disclosure, and based on these drawings, a person skilled in the art may obtain the other drawings without any creative effort. Shapes and sizes of the members in the drawings are for illustrative purposes only, but shall not be used to reflect any actual scale.

FIG. 1 is a flow chart of a substrate lamination method according to one embodiment of the present disclosure;

FIG. 2 is a schematic view showing a lamination surface of a liquid crystal panel divided into a plurality of first regions according to one embodiment of the present disclosure;

FIG. 3 is a schematic view showing a lamination surface of a touch panel divided into a plurality of second regions according to one embodiment of the present disclosure;

FIG. 4 is a schematic view showing a situation where a surface feature image of the liquid crystal panel is acquired by an image collector according to one embodiment of the present disclosure; and

FIG. 5 is a schematic view showing a substrate lamination device according to one embodiment of the present disclosure.

### DETAILED DESCRIPTION OF THE EMBODIMENTS

In order to make the objects, the technical solutions and the advantages of the present disclosure more apparent, the present disclosure will be described hereinafter in details in conjunction with the drawings and embodiments.

Unless otherwise defined, any technical or scientific term used herein shall have the common meaning understood by a person of ordinary skills. Such words as “first” and “second” used in the specification and claims are merely used to differentiate different components rather than to represent any order, number or importance. Similarly, such words as “one” or “one of” are merely used to represent the existence of at least one member, rather than to limit the number thereof. Such words as “comprising” or “including” are merely used to represent that the element or object presented prior to the word contain the elements or objects or the equivalents enumerated subsequent to the word, rather than to preclude the possibility of further containing other elements or objects. Such words as “connect” or “connected to” may include electrical connection, direct or indirect, rather than to be limited to physical or mechanical connection. Such words as “on”, “under”, “left” and “right” are merely used to represent relative position relationship, and when an absolute position of the object is changed, the relative position relationship may be changed too.

It should be appreciated that, in the case that such an element as layer, film, region or substrate is arranged “on” or “under” another element, it may be directly arranged “on” or “under” the other element, or an intermediate element may be arranged therebetween.

Usually, a cover plate or a touch panel needs to be laminated onto a display panel, e.g., a liquid crystal panel or an OLED panel in a frame-type lamination or full lamination mode. In the frame-type lamination mode, an edge of the to-be-laminated display panel is laminated to an edge of a to-be-laminated medium. However, due to an air gap between the display panel and the to-be-laminated medium, reflectivity of a resultant display product may increase, so readability of the display product in a strong light environment may be adversely affected. In the full lamination mode, an adhesive is fully filled between the display panel and the to-be-laminated medium. The display product in the full lamination mode is significantly advantageous over the display product in the frame-type lamination mode in terms of the readability in the strong light environment. However, surfaces of the display panel and the to-be-laminated medium are not completely flat, and when the adhesive is coated at each region of the display product at a same amount, a resultant adhesive layer may have different flatness at different regions of the display product. When an external force is applied to the display panel of the display product in the full lamination mode, such a phenomenon as yellow spot may occur. In order to prevent the occurrence of yellow spot, different adhesive patterns are adopted in the related art to ensure the flatness of the adhesive layer, but with limited benefit.

An object of the present disclosure is to provide a substrate lamination method, a substrate lamination device, and a computer-readable storage medium, so as to prevent the occurrence of yellow spot due to an external force applied to the display panel of the display product in the full lamination mode, thereby to improve a display effect of the display product.

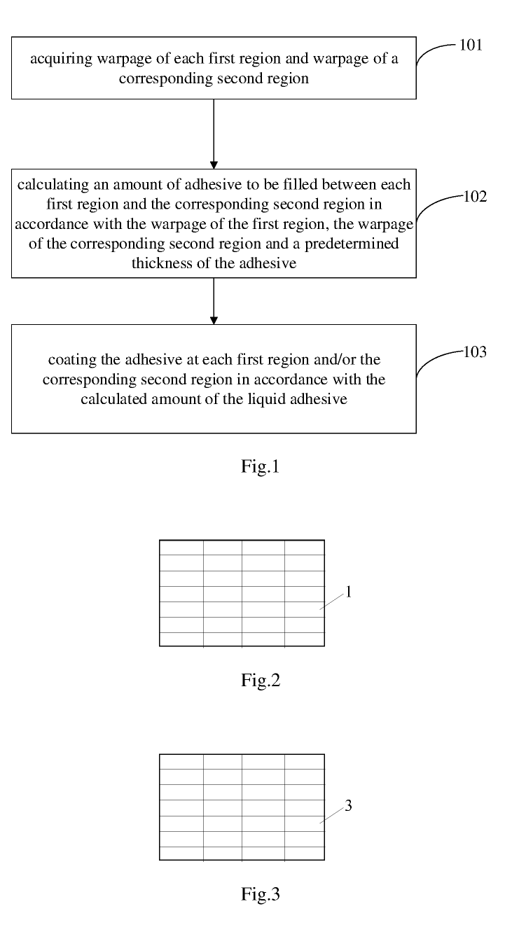

The present disclosure provides in some embodiments a substrate lamination method for laminating a first to-be-laminated substrate onto a second to-be-laminated substrate in a full lamination mode. A lamination surface of the first to-be-laminated substrate includes a plurality of first regions, and a lamination surface of the second to-be-laminated substrate includes a plurality of second regions each corresponding to a respective one of the first regions. As shown in FIG. 1, the substrate lamination method includes: Step 101 of acquiring warpage of each first region and warpage of the corresponding second region; and Step 102 of calculating an amount of adhesive to be filled between each first region and the corresponding second region in accordance with the warpage of the first region, the warpage of the corresponding second region and a predetermined thickness of the adhesive.

In the embodiments of the present disclosure, at first the warpage of each region on the lamination surface of each of the two to-be-laminated substrates may be acquired, then the amount of the adhesive to be coated at each first region or the corresponding second region may be calculated in accordance with the warpage of each first region, the warpage of the corresponding second region and the predetermined thickness of the adhesive, and then the adhesive may be coated at each first region and/or the corresponding second region in accordance with the calculated amount of the adhesive. In this way, it is able to accurately control the amount of the adhesive at each region and ensure the flatness of a resultant adhesive layer, thereby to reduce the occurrence of yellow spot and any other display defects due to the unflatness of the resultant adhesive layer and the external force applied to a display panel, and improve the reliability of a display product in a full lamination mode as well as a lamination success rate.

In a possible embodiment of the present disclosure, the number of the first regions is equal to the number of the second regions, each first region has a same area and a same shape as the corresponding second region, and a relative position of each first region on the first to-be-laminated substrate is the same as a relative position of the corresponding second region on the second to-be-laminated substrate so that each first region completely coincides with the corresponding second region after the first to-be-laminated substrate has been laminated onto the second to-be-laminated substrate.

In a possible embodiment of the present disclosure, subsequent to calculating the amount of the adhesive to be filled between each first region and the corresponding second region, as shown in FIG. 1, the substrate lamination method further includes: Step 103 of coating the adhesive at each first region and/or the corresponding second region in accordance with the calculated amount of the adhesive, wherein the adhesive may be liquid adhesive.

In a possible embodiment of the present disclosure, the acquiring the warpage of each first region and the warpage of the corresponding second region includes: acquiring a surface feature image of each first region through an image collector, determining a warpage distribution of the first region in accordance with the surface feature image, and calculating average warpage in accordance with the warpage distribution of the first region as the warpage of the first region; and acquiring a surface feature image of each second region through the image collector, determining a warpage distribution of the second region in accordance with the surface feature image, and calculating average warpage in accordance with the warpage distribution of the second region as the warpage of the second region.

The number of the first regions on the lamination surface of the first to-be-laminated substrate, the positions thereof, the number of the second regions on the lamination surface of the second to-be-laminated substrate and the positions thereof may be set in advance. Then, the surface feature images of each first region and each second region may be collected directly by the image collector. Alternatively, a surface feature image of the entire lamination surface of the first to-be-laminated substrate may be acquired, and then divided in accordance with the predetermined number of the first regions, so as to acquire the surface feature image of each first region. Similarly, a surface feature image of the entire lamination surface of the second to-be-laminated substrate may be acquired, and then divided in accordance with the predetermined number of the second regions, so as to acquire the surface feature image of each second region.

The number of the first regions and the number of the second regions will not be particularly defined herein, e.g., the lamination surface of the first to-be-laminated substrate may be divided into 16 or 28 regions. A shape of each first region or each second region will not be particularly defined herein, e.g., each first region or each second region may be of a rectangular shape or a regular polygon shape. In addition, the first regions on the first to-be-laminated substrate may be of a same size or different sizes.

The image collector may be an infrared sensor, an image sensor, or any other device capable of acquiring the surface feature image. After the acquisition of the surface feature image of each region through the image collector and the determination of the warpage distribution, the average warpage may be calculated as the warpage of the region. In this way, it is able to represent the warpage of each region in a better manner.

In a possible embodiment of the present disclosure, the calculating the amount of the adhesive to be filled between each first region and the corresponding second region in accordance with the warpage of each first region, the warpage of the corresponding second region and the predetermined thickness of the adhesive includes: calculating an actual thickness H of the adhesive at each first region in accordance with the warpage of each first region, the warpage of the corresponding second region and the predetermined thickness of the adhesive; and calculating the amount L of the adhesive through multiplying the actual thickness H by an area S of the first region.

For example, at a certain first region, the lamination surface of the first to-be-laminated substrate protrudes outwardly and has a height of H₁, and at the second region corresponding to the certain first region, the lamination surface of the second to-be-laminated substrate protrudes outwardly and has a height of H₂. At this time, the actual thickness Hₓ₁ of the adhesive at the first region may be greater than the predetermined thickness H₀, i.e., Hₓ₁=H₀+H₁+H₂.

For another example, at a certain first region, the lamination surface of the first to-be-laminated substrate protrudes inwardly and has a height of H₃, and at the second region corresponding to the certain first region, the lamination surface of the second to-be-laminated substrate protrudes inwardly and has a height of H₄. At this time, the actual thickness Hₓ₂ of the adhesive at the first region may be smaller than the predetermined thickness H₀, i.e., Hₓ₂=H₀−H₃−H₄.

Here, the so-called “protrude outwardly” refers to that the lamination surface of one of the two to-be-laminated substrates protrudes in a direction opposite to the other to-be-laminated substrate in the case that the two to-be-laminated substrates have been laminated onto each other, and the so-called “protrude inwardly” refers to that the lamination surface of one of the two to-be-laminated substrates protrudes in a direction towards the other to-be-laminated substrate in the case that the two to-be-laminated substrates have been laminated onto each other. Taking the first to-be-laminated substrate as an example, in the case that the lamination surface of the first to-be-laminated substrate protrudes outwardly, the lamination surface of the first to-be-laminated substrate may protrude in a direction opposite to the second to-be-laminated substrate.

In a possible embodiment of the present disclosure, the coating the liquid adhesive at each first region and/or the corresponding second region in accordance with the calculated amount of the adhesive includes: coating the liquid adhesive with a predetermined pattern at each first region and/or the corresponding second region, and the predetermined pattern includes at least one of an X shape and a Y shape. As compared with a situation where the liquid adhesive is coated at the first region or the second region in a dot or block manner, when the liquid adhesive is coated at each first or second region in an X-shaped or Y-shaped manner, it is able to improve the diffusion uniformity when then liquid adhesive is leveled, thereby to further improve the flatness of the adhesive.

The substrate lamination method will be described hereinafter in more details when the first to-be-laminated substrate is a liquid crystal panel and the second to-be-laminated substrate is a touch panel.

At first, before the lamination, warpage of lamination surface of the liquid crystal panel 1 and warpage of lamination surface of the touch panel 3 may be detected. As shown in FIG. 2, the lamination surface of the liquid crystal panel 1 may be divided into 28 first regions, and as shown in FIG. 3, the lamination surface of the touch panel 3 may be divided into 28 second regions each corresponding to a respective one of the 28 first regions. After the liquid crystal panel 1 has been laminated onto the touch panel 3, an orthogonal projection of each second region onto the liquid crystal panel 1 completely coincides with the first region corresponding to the second region.

As shown in FIG. 4, a surface feature image of each first region of the liquid crystal panel 1 may be acquired through an image collector 2, a warpage distribution of each first region may be determined in accordance with the surface feature image, and then average warpage may be calculated in accordance with the warpage distribution of the first region as the warpage of the first region. In addition, a surface feature image of each second region of the touch panel 3 may be acquired through the image collector 2, a warpage distribution of each second region may be determined in accordance with the surface feature image, and then average warpage may be calculated in accordance with the warpage distribution of the second region as the warpage of the second region. Then, the warpage of each first region and the warpage of each second region may be stored.

The actual thickness H of the adhesive at each first region may be calculated in accordance with the warpage of each first region, the warpage of the corresponding second region and the predetermined thickness of the adhesive, and then the actual thickness H may be multiplied by the area S of each first region so as to acquire the amount L of the adhesive, where S is 1/28 of a total area of the lamination surface of the liquid crystal panel 1. In this way, it is able to acquire the amount of the adhesive corresponding to each of the 28 first regions. Then, positions of the 28 first regions and the amount of adhesive corresponding to each first region may be stored in a database.

During the coating of the adhesive, the amount of the adhesive to be filled may be called from the database, so as to accurately control the amount of the adhesive to be coated at each first region. In this way, it is able to ensure the flatness of a resultant adhesive layer, and reduce the occurrence of yellow spot and any other display defects due to the unflatness of the resultant adhesive layer and the external force applied to the liquid crystal panel 1, thereby to improve the reliability of the display product in the full lamination mode as well as a lamination success rate.

Although the lamination surface of the liquid crystal panel 1 is divided into 28 first regions as mentioned above, the present disclosure may not be limited thereto, i.e., the lamination surface of the liquid crystal panel 1 may be divided into the first regions in any other amount in accordance with its total area. In addition, although the liquid crystal panel 1 is laminated onto the touch panel 3 as mentioned above, the present disclosure may not be limited thereto, e.g. the liquid crystal panel 1 may also be laminated onto a cover glass substrate or a heating glass substrate. The present disclosure may be applied as long as two to-be-substrate substrates need to be laminated onto each other in the full lamination mode.

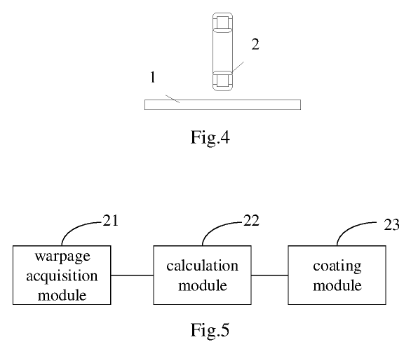

The present disclosure further provides in some embodiments a substrate lamination device for laminating a first to-be-laminated substrate onto a second to-be-laminated substrate in a full lamination mode. A lamination surface of the first to-be-laminated substrate includes a plurality of first regions, and a lamination surface of the second to-be-laminated substrate includes a plurality of second regions each corresponding to a respective one of the first regions. As shown in FIG. 5, the substrate lamination device includes: a warpage acquisition module 21 configured to acquire warpage of each first region and warpage of the corresponding second region; and a calculation module 22 configured to calculate an amount of adhesive to be filled between each first region and the corresponding second region in accordance with the warpage of the first region, the warpage of the corresponding second region and a predetermined thickness of the adhesive.

In the embodiments of the present disclosure, at first the warpage of each region on the lamination surface of each of the two to-be-laminated substrates may be acquired, then the amount of the adhesive to be coated at each first region or the corresponding second region may be calculated in accordance with the warpage of each first region, the warpage of the corresponding second region and the predetermined thickness of the adhesive, and then the adhesive may be coated at each first region and/or the corresponding second region in accordance with the calculated amount of the adhesive. In this way, it is able to accurately control the amount of the adhesive at each region and ensure the flatness of a resultant adhesive layer, thereby to reduce the occurrence of yellow spot and any other display defects due to the unflatness of the resultant adhesive layer and the external force applied to a display panel, and improve the reliability of a display product in a full lamination mode as well as a lamination success rate.

In a possible embodiment of the present disclosure, as shown in FIG. 5, the substrate lamination device further includes: a coating module 23 configured to coat the liquid adhesive at each first region and/or the corresponding second region in accordance with the calculated amount of the adhesive.

In a possible embodiment of the present disclosure, the warpage acquisition module includes: an image collector configured to acquire a surface feature image of each first region and a surface feature image of the corresponding second region; and a processing circuitry configured to determine a warpage distribution of the first region in accordance with the surface feature image of the first region, calculate an average warpage in accordance with the warpage distribution of the first region as the warpage of the first region, determine a warpage distribution of the second region in accordance with the surface feature image of the second region, and calculate an average warpage in accordance with the warpage distribution of the second region as the warpage of the second region.

The image collector may be an infrared sensor, an image sensor, or any other device capable of acquiring the surface feature image. After the acquisition of the surface feature image of each region through the image collector and the determination of the warpage distribution according to the surface feature image of each region, the average warpage may be calculated as the warpage of the region. In this way, it is able to represent the warpage of each region in a better manner.

In a possible embodiment of the present disclosure, the calculation module 22 is further configured to: calculate an actual thickness H of the adhesive at each first region in accordance with the warpage of each first region, the warpage of the corresponding second region and the predetermined thickness of the adhesive, and obtain the amount L of the adhesive through multiplying the actual thickness H by an area S of the first region.

For example, at a certain first region, the lamination surface of the first to-be-laminated substrate protrudes outwardly and has a height of H₁, and at the corresponding second region, the lamination surface of the second to-be-laminated substrate protrudes outwardly and has a height of H₂. At this time, the actual thickness Hₓ₁ of the adhesive at the first region may be greater than the predetermined thickness H₀, i.e., Hₓ₁=H₀+H₁+H₂.

For another example, at another certain first region, the lamination surface of the first to-be-laminated substrate protrudes inwardly and has a height of H₃, and at the corresponding second region, the lamination surface of the second to-be-laminated substrate protrudes inwardly and has a height of H₄. At this time, the actual thickness Hₓ₂ of the adhesive at the first region may be smaller than the predetermined thickness H₀, i.e., Hₓ₂=H₀−H₃−H₄.

In a possible embodiment of the present disclosure, the coating module 23 is further configured to coat the liquid adhesive with a predetermined adhesive pattern at each first region and/or the corresponding second region, and the predetermined adhesive pattern includes at least one of an X shape and a Y shape. As compared with a situation where the liquid adhesive is coated at the first region or the second region in a dot or block manner, when the liquid adhesive is coated at each first or second region in an X-shaped or Y-shaped manner, it is able to improve the diffusion uniformity when the liquid adhesive is leveled, thereby to further improve the flatness of the liquid adhesive.

The warpage acquisition module 21, the calculation module 22 and a processing circuit may each be implemented via a corresponding hardware circuit, including a Very Large Scale Integrated Circuit (VLSIC), a gate array, a semiconductor such as a logic chip or transistor, or any other discrete element in the related art. In addition, the warpage acquisition module 21, the calculation module 22 and the processing circuit may each be implemented via a programmable hardware device, e.g., Field-Programmable Gate Array (FPGA), Programmable Array Logic (PAL) or Programmable Logic Device (PLD). The coating module 23 may include a mechanical structure capable of performing a coating operation and a hardware circuit capable of controlling the operation of the mechanical structure.

The present disclosure further provides in some embodiments a substrate lamination device for laminating a first to-be-laminated substrate onto a second to-be-laminated substrate in a full lamination mode. The substrate lamination device includes a memory, a processor and a computer program stored in the memory and capable of being executed by the processor. A lamination surface of the first to-be-laminated substrate includes a plurality of first regions, and a lamination surface of the second to-be-laminated substrate includes a plurality of second regions each corresponding to a respective one of the first regions. The computer program is executed by the processor so as to: acquire warpage of each first region and warpage of the corresponding second region; and calculate an amount of adhesive to be filled between each first region and the corresponding second region in accordance with the warpage of the first region, the warpage of the corresponding second region and a predetermined thickness of the adhesive.

In a possible embodiment of the present disclosure, the processor is further configured to execute the computer program, so as to coat the adhesive at each first region and/or the corresponding second region in accordance with the calculated amount of the adhesive, wherein the adhesive is liquid adhesive.

In a possible embodiment of the present disclosure, the processor is further configured to execute the computer program so as to: acquire a surface feature image of each first region through an image collector, determine a warpage distribution of the first region in accordance with the surface feature image of the first region, and calculate average warpage in accordance with the warpage distribution of the first region as the warpage of the first region; and acquire a surface feature image of each second region through the image collector, determine a warpage distribution of the second region in accordance with the surface feature image of the second region, and calculate average warpage in accordance with the warpage distribution of the second region as the warpage of the second region.

In a possible embodiment of the present disclosure, the processor is further configured to execute the computer program so as to: calculate an actual thickness H of the adhesive at each first region in accordance with the warpage of each first region, the warpage of the corresponding second region and the predetermined thickness of the adhesive; and obtain the amount L of the adhesive through multiplying the actual thickness H by an area S of the first region.

In a possible embodiment of the present disclosure, the processor is further configured to execute the computer program so as to: coat the liquid adhesive with a predetermined liquid pattern at each first region and/or the corresponding second region, and the predetermined liquid pattern includes at least one of an X shape and a Y shape.

The present disclosure further provides in some embodiments a computer-readable storage medium storing therein a computer program. The computer program is executed by a processor so as to implement the above-mentioned substrate lamination method.

The computer-readable storage medium may include volatile or nonvolatile, mobile or immobile storage medium capable of storing therein information using any method or technique. The information may be a computer-readable instruction, a data structure, a program module or any other data. The computer-readable storage medium may include, but not limited to, a Random Access Memory (e.g., Phase-change Random Access Memory (PRAM), Static Random Access Memory (SRAM) or Dynamic Random Access Memory (DRAM)), a Read Only Memory (ROM), an Electrically Erasable Programmable Read Only Memory (EEPROM), a flash memory, a Compact Disc Read Only Memory (CD-ROM), a Digital Video Disk (DVD), an optical storage device, a magnetic storage device (e.g., a cassette magnetic tape or a magnetic disk), or any other non-transmission medium capable of storing therein information which can be accessed by a computing device. As defined in the present disclosure, the computer-readable storage medium may not include any transitory media, e.g., modulated data signal or carrier.

The above embodiments are merely the preferred embodiments of the present disclosure. Obviously, a person skilled in the art may make further modifications and improvements without departing from the spirit of the present disclosure, and these modifications and improvements shall also fall within the scope of the present disclosure.

What is claimed is:

1. A substrate lamination method for laminating a first to-be-laminated substrate onto a second to-be-laminated substrate in a full lamination mode, wherein a lamination surface of the first to-be-laminated substrate comprises a plurality of first regions, a lamination surface of the second to-be-laminated substrate comprises a plurality of second regions, and the first regions correspond one-to-one with the second regions,
wherein the substrate lamination method comprises:
acquiring warpage of each of the first regions and warpage of the second region corresponding to the first region; and
calculating an amount of adhesive to be filled between each of the first regions and the second region corresponding to the first region in accordance with the warpage of the first region, the warpage of the second region corresponding to the first region and a predetermined thickness of the adhesive.

2. The substrate lamination method according to claim 1, wherein the substrate lamination method further comprises:
subsequent to calculating the amount of the adhesive to be filled between each of the first regions and the second region corresponding to the first region, coating the calculated amount of the adhesive at each of the first regions and/or the second region corresponding to the first region, wherein the adhesive is liquid adhesive.

3. The substrate lamination method according to claim 1, wherein the acquiring the warpage of each of the first regions and the warpage of the second region corresponding to the first region comprises:
acquiring a surface feature image of each of the first regions through an image collector, determining a warpage distribution of the first region in accordance with the surface feature image of the first region, and calculating average warpage of the first region in accordance with the warpage distribution of the first region, to determine the average warpage of the first region as the warpage of the first region; and
acquiring a surface feature image of each of the second regions through the image collector, determining a warpage distribution of the second region in accordance with the surface feature image of the second region, and calculating average warpage of the second region in accordance with the warpage distribution of the second region, to determine the average warpage of the second region as the warpage of the second region.

4. The substrate lamination method according to claim 1, wherein the calculating the amount of the adhesive to be filled between each of the first regions and the second region corresponding to the first region in accordance with the warpage of each of the first regions, the warpage of the second region corresponding to the first region and the predetermined thickness of the adhesive comprises:
calculating an actual thickness H of the adhesive at each of the first regions in accordance with the warpage of each of the first regions, the warpage of the second region corresponding to the first region and the predetermined thickness of the adhesive; and
acquiring the amount L of the adhesive to be filled between each of the first regions and the second region corresponding to the first region through multiplying the actual thickness H by an area S of the first region.

5. The substrate lamination method according to claim 2, wherein the coating the calculated amount of the adhesive at each of the first regions and/or the second region corresponding to the first region comprises:
coating the adhesive of a predetermined pattern at each of the first regions and/or the second region corresponding to the first region, wherein the predetermined pattern comprises at least one of an X shape and a Y shape.

6. The substrate lamination method according to claim 1, wherein
the number of the first regions is equal to the number of the second regions, each of the first regions has a same area and a same shape as the second region corresponding to the first region, and a relative position of each of the first regions on the first to-be-laminated substrate is the same as a relative position of the second region corresponding to the first region on the second to-be-laminated substrate, to enable that each of the first regions completely coincides with the second region corresponding to the first region after the first to-be-laminated substrate has been laminated onto the second to-be-laminated substrate.

7. A substrate lamination device for laminating a first to-be-laminated substrate onto a second to-be-laminated substrate in a full lamination mode, wherein a lamination surface of the first to-be-laminated substrate comprises a plurality of first regions, and a lamination surface of the second to-be-laminated substrate comprises a plurality of second regions, and the first regions correspond one-to-one with the second regions,
wherein the substrate lamination device comprises:
a warpage acquisition module configured to acquire warpage of each of the first regions and warpage of the second region corresponding to the first region; and
a calculation module configured to calculate an amount of adhesive to be filled between each of the first regions and the second region corresponding to the first region in accordance with the warpage of the first region, the warpage of the second region corresponding to the first region and a predetermined thickness of the adhesive.

8. The substrate lamination device according to claim 7, further comprising:
a coating module configured to coat the calculated amount of the adhesive at each of the first regions and/or the second region corresponding to the first region, wherein the adhesive is liquid adhesive.

9. The substrate lamination device according to claim 7, wherein the warpage acquisition module comprises:
an image collector configured to acquire a surface feature image of each of the first regions and a surface feature image of the second region corresponding to the first region; and
a processing circuitry configured to determine a warpage distribution of the first region in accordance with the surface feature image of the first region, calculate an average warpage of the first region in accordance with the warpage distribution of the first region to determine the average warpage of the first region as the warpage of the first region, determine a warpage distribution of the second region in accordance with the surface feature image of the second region, and calculate an average warpage of the second region in accordance with the warpage distribution of the second region to determine the average warpage of the second region as the warpage of the second region.

10. The substrate lamination device according to claim 7, wherein the calculation module is further configured to:
calculate an actual thickness H of the adhesive at each of the first regions in accordance with the warpage of each of the first regions, the warpage of the second region corresponding to the first region and the predetermined thickness of the adhesive; and
acquire the amount L of the adhesive to be filled between each of the first regions and the second region corresponding to the first region through multiplying the actual thickness H by an area S of the first region.

11. The substrate lamination device according to claim 8, wherein the coating module is further configured to:
coat the adhesive of a predetermined pattern at each of the first regions and/or the second region corresponding to the first region, wherein the predetermined pattern comprises at least one of an X shape and a Y shape.

12. The substrate lamination device according to claim 7, wherein
the number of the first regions is equal to the number of the second regions, each of the first regions has a same area and a same shape as the second region corresponding to the first region, and a relative position of each of the first regions on the first to-be-laminated substrate is the same as a relative position of the second region corresponding to the first region on the second to-be-laminated substrate, to enable that each of the first regions completely coincides with the second region corresponding to the first region after the first to-be-laminated substrate has been laminated onto the second to-be-laminated substrate.

13. A substrate lamination device for laminating a first to-be-laminated substrate onto a second to-be-laminated substrate in a full lamination mode, wherein a lamination surface of the first to-be-laminated substrate comprises a plurality of first regions, a lamination surface of the second to-be-laminated substrate comprises a plurality of second regions, and the first regions correspond one-to-one with the second regions,
wherein the substrate lamination device comprises a memory, a processor and a computer program stored in the memory and capable of being executed by the processor, and the processor is configured to execute the computer program to:
acquire warpage of each of the first regions and warpage of the second region corresponding to the first region; and
calculate an amount of adhesive to be filled between each of the first regions and the second region corresponding to the first region in accordance with the warpage of the first region, the warpage of the second region corresponding to the first region and a predetermined thickness of the adhesive.

14. The substrate lamination device according to claim 13, wherein the processor is further configured to execute the computer program to:
subsequent to calculating the amount of the adhesive to be filled between each of the first regions and the second region corresponding to the first region, coat the calculated amount of the adhesive at each of the first regions and/or the second region corresponding to the first region, wherein the adhesive is liquid adhesive.

15. The substrate lamination device according to claim 13, wherein the processor is further configured to execute the computer program to:
acquire a surface feature image of each of the first regions through an image collector, determine a warpage distribution of the first region in accordance with the surface feature image of the first region, and calculate average warpage of the first region in accordance with the warpage distribution of the first region, to determine the average warpage of the first region as the warpage of the first region; and
acquire a surface feature image of each of the second regions through the image collector, determinate a warpage distribution of the second region in accordance with the surface feature image of the second region, and calculate average warpage of the second region in accordance with the warpage distribution of the second region, to determine the average warpage of the second region as the warpage of the second region.

16. The substrate lamination device according to claim 13, wherein the processor is further configured to execute the computer program to:
calculate an actual thickness H of the adhesive at each of the first regions in accordance with the warpage of each of the first regions, the warpage of the second region corresponding to the first region and the predetermined thickness of the adhesive; and
acquire the amount L of the adhesive to be filled between each of the first regions and the second region corresponding to the first region through multiplying the actual thickness H by an area S of the first region.

17. The substrate lamination device according to claim 14, wherein the processor is further configured to execute the computer program to:
coat the adhesive of a predetermined pattern at each of the first regions and/or the second region corresponding to the first region, wherein the predetermined pattern comprises at least one of an X shape and a Y shape.

18. The substrate lamination device according to claim 13, wherein
the number of the first regions is equal to the number of the second regions, each of the first regions has a same area and a same shape as the second region corresponding to the first region, and a relative position of each of the first regions on the first to-be-laminated substrate is the same as a relative position of the second region corresponding to the first region on the second to-be-laminated substrate, to enable that each of the first regions completely coincides with the second region corresponding to the first region after the first to-be-laminated substrate has been laminated onto the second to-be-laminated substrate.

19. A computer-readable storage medium storing therein a computer program, wherein a processor is configured to execute the computer program to implement the substrate lamination method according to claim 1.

20. The computer-readable storage medium according to claim 19, wherein the processor is further configured to execute the computer program to:
subsequent to calculating the amount of the adhesive to be filled between each of the first regions and the second region corresponding to the first region, coat the calculated amount of the adhesive at each of the first regions and/or the second region corresponding to the first region, wherein the adhesive is liquid adhesive.
